(19) United States
(12) Patent Application Publication
(10) Pub. No.: US 2007/0067569 A1
(43) Pub. Date: Mar. 22, 2007

(54) Method and system for communicating validation information to a web cache

(75) Inventors: Mahesh Vittal, Chennai (IN); Kumar Thiagarajan, Chennai (IN); Srinivasan Santhanam, Chennai (IN); Suresh Pachiappan, Chennai (IN)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/232,583

(22) Filed: Sep. 21, 2005

(51) Int. Cl. G06F 12/00

(52) U.S. Cl. 711/118

(57) ABSTRACT

A method and apparatus for communicating validation information from a web server to validate a web cache is provided. The method includes generation of a file storing information pertaining to the objects being served by the web server. The contents of the file are updated by means of modifications in the objects. The contents of the file can be communicated to the web cache. The web cache, based on the information received by it, validates its cached objects.

### BACKGROUND OF THE INVENTION

1. Field of Invention

Embodiments of the invention relate in general to a web cache. More specifically, the embodiments of the invention relate to methods and systems for communicating validation information to a web cache.

2. Description of the Background Art

A web sever contains objects that are accessed by one or more clients. An increase in the number of clients results in a corresponding rise in web server bandwidth usage. This may result in a long waiting time for clients wanting to access objects on the web server. Therefore, a web cache is provided, which saves a copy of the objects that can then be accessed by clients. The objects on the web server can change with time. The web caches require a mechanism to pro-actively update the cached objects with changes in the objects on the web server. The process of updating a web cache is also known as revalidation of a web cache. Pro-active revalidation ensures an increased number of cache hits when clients request access to objects.

In one of the conventional techniques for revalidation of a web cache, the web cache itself revalidates the objects or a subset of objects stored in the cache. However, there are instances when a cached object is revalidated by the web cache although it has not been changed on the web server. The computational time spent in revalidating objects that have not been changed, and the network bandwidth utilized for this kind of revalidation, is redundant and results in wastage of resources.

In another conventional technique, active caching is utilized. Active caching pertains to capability of the web cache to analyze the cache access pattern. Decisions to keep popular contents up-to-date in the cache are taken on the basis of this pattern. However, there can be some cached objects that change but are not popular. These cached objects may not be revalidated.

Some conventional techniques identify useful relationships among objects being served by the web server, and use these relationships to keep all the objects consistent. The relationships of the objects are combined with object change characteristics to manage cache consistency. However, identifying the relationships and selecting the frequently changing objects puts an extra load on web servers, since they require additional processing.

According to another conventional technique, the web server uses proxy filters to maintain the server volume and reduce the overhead of piggybacking server responses. However, this technique requires a separate router or a gateway to perform the tasks of volume maintenance.

Further, some of the conventional methods require the web server to send volume leases for objects. These leases require the web servers to keep a record of the clients to whom the objects were served and invalidate specific contents. However, the volume leases needs to be invalidated by contacting all the clients that obtained access to the leases. Therefore, the web server requires additional time and is subject to an additional load before updating the object being served. This technique is not optimal in a wireless area network (WAN).

According to another conventional method, cache staleness is decreased by using a cache replacement policy and a cache coherency policy. This method uses a proxy client. Further, the method describes a process for piggyback cache validation (PCV). In this process, the objects on the web cache are partitioned on the basis of the origin server. Each time the server is accessed for its contents, the proxy client piggybacks a list of potentially stale cached objects onto the request. The web server serves the request and piggybacks the list of stale cached objects. Furthermore, the method describes a process for piggyback server invalidation (PSI). In PSI, the contents on the web server are partitioned into volume(s), either a single one or several related subsets. Each volume is associated with an identifier and a version. Each time the web server receives a request from the proxy client, along with the last known version of the volume, the web server piggybacks a list of modified volume resources. Further, the conventional technique combines the PCV and PSI methods to maintain cache coherency. However, this method requires a separate proxy client for cache validation.

### BRIEF DESCRIPTION OF THE DRAWINGS

FIG. 1 illustrates a network environment, wherein the embodiments of the invention can be practiced.

FIG. 2 illustrates a system for communicating validation information, in accordance with an exemplary embodiment of the present invention.

FIG. 3 is a flowchart depicting the requisite steps for communicating validation information, in accordance with an exemplary embodiment of the present invention.

### DETAILED DESCRIPTION OF EMBODIMENTS OF THE INVENTION

The various embodiments of the invention provide a method, a system, and a machine-readable medium for communicating information to a web cache. The embodiments of the invention provide a method for communicating validation information from a web server to the web cache. The method includes generating a file on the web server that contains information pertaining to the content, which is modified, added to, or deleted from the web server. The information in this file is updated to indicate the latest modifications to the content on the web server. This information is communicated to the web cache that uses it to compare it with the content in its cache, which is also referred to as cached objects. The web cache revalidates the cached content, which appears different from the contents of the web server, when compared.

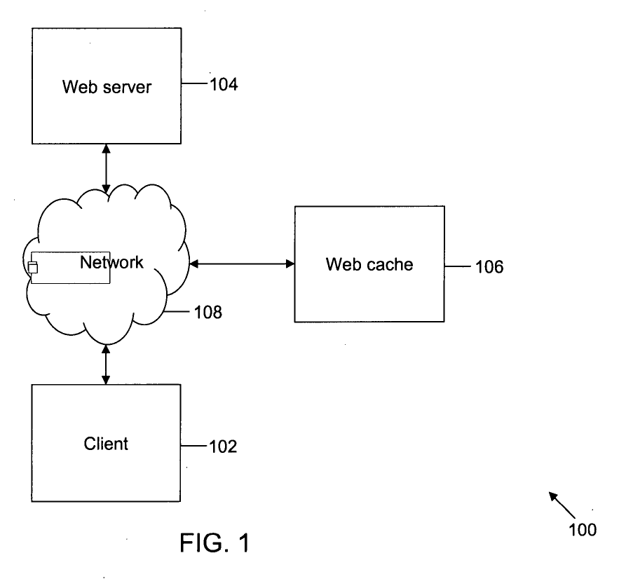

FIG. 1 illustrates a network environment 100, wherein the various embodiments of the invention can be practiced. Network environment 100 includes a client 102, a web server 104, and a web cache 106 connected to each other through a network 108. Client 102 may be considered as a program running on a computing device, which requests access to the content from another computing device, through network 108. According to the various embodiments of the invention, the other computing device can be web server 104. The content present on web server 104 can also be called objects. In an embodiment, web server 104 is a program that handles requests for access to the objects on a web page, requested by users at client 102. These objects, which are served by web server 104, can be stored in a separate location. According to the various embodiments of the invention, the separate location is web cache 106, which provides space for storing a copy of the objects being served by web server 104. Once the copy of an object is stored in web cache 106, the user can access the object from it.

According to the various embodiments of the invention, client 102 communicates with web server 104 through network 108. In addition, client 102 can access the cached objects of web cache 106 through network 108. Examples of network 108 include, but are not limited to, a Local Area Network (LAN), a Wide Area Network (WAN), a Metropolitan Area Network (MAN), and a Virtual Private Network (VPN). In one embodiment, a physical cable makes the connections in network environment 100. In another embodiment, the connection can be a wireless connection.

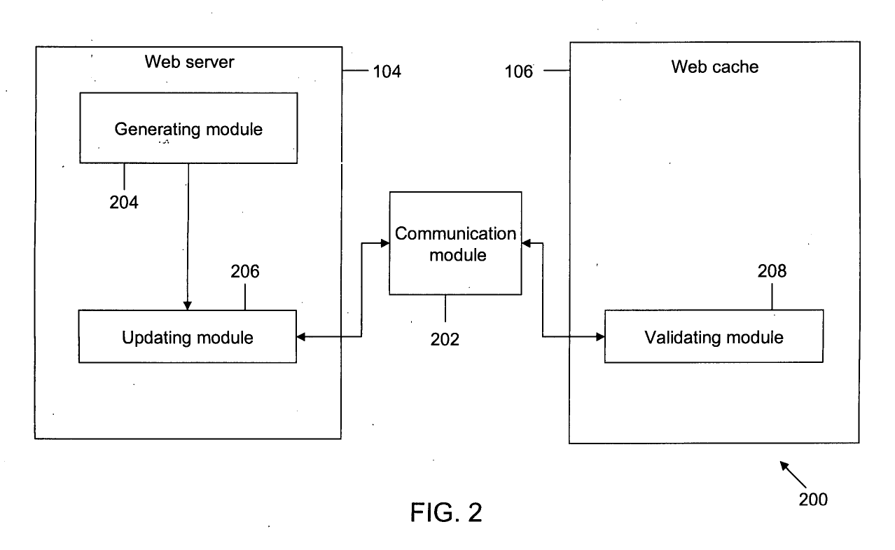

FIG. 2 illustrates a system 200 for communicating validation information, in accordance with an exemplary embodiment of the present invention. System 200 includes web server 104, web cache 106, and a communication module 202. Web server 104 interacts with web cache 106 via communication module 202.

Web server 104 includes a generating module 204 and an updating module 206. Generating module 204 generates a file, which contains information related to the objects being served by web server 104. In an embodiment, the file can be an entity of objects, containing information pertaining to all the objects served by web server 104. In another embodiment, the file may contain information relating only to objects that have been modified during a specific time period. For example, the information contained in the file can be metadata corresponding to the objects served by web server 104. This metadata can include a description of the objects. In one embodiment, the description of the objects may include the characteristics of the objects, such as their size, their type, and process information pertaining to them. The metadata can also be specifications of the objects. According to an embodiment, the specifications of an object can mention the location of the object and the time stamp on it. The time stamp indicates the time when the object was last modified. This is illustrated in the following example file:

| Location path | Last modified |
|---|---|
| web server/objects/static. jpg | May 19, 2005 |

In another embodiment, the file may only contain a time stamp. According to various embodiments, the file can be created in a mark-up language such as the Extensible Mark-up Language (XML). An example of the file created using XML, which includes the information relating to the objects that are modified on web server 104, is illustrated in the following example file:

<Change-Log version=1.1 >

<directory name= public >

<file name= “a “ size= “5MB “ last_modified=”May 19,
2005” />
<file name= “b “ size= “6MB “ last_modified=”May 19,
2005” />
<file name=”c “ size= “7MB “ last_modified=”May 19,
2005” />

</directory>

</Change-Log>

In the above example, ‘Change-Log version’ provides the version of the file. The file with version 1.1 indicates that objects ‘a’, ‘b’ and ‘c’ on web server 104 are modified. Moreover, the file includes the time at which these objects were last modified on web server 104.

In an exemplary embodiment, the file is generated periodically by generating module 204. In another exemplary embodiment, an administrator for web server 104 generates the file at a desired frequency. Further, according to an embodiment, generating module 202 may generate the file only when an object in the file modifies, resulting in the modification of the information pertaining to the object in the file.

The information related to the modification of the object is updated in the file with the help of updating module 206. Thereby, updating module 206 updates the contents of the file. In one embodiment, updating module 206 updates the time stamp in the file. This type of update involves recording the time at which the object was last modified, and updating the same in the file. In another embodiment, the file may contain a content path of an object. The content path indicates the location at which the modified object is present. For example, the content path may indicate the directory in which a modified object is located. In this case, updating module 206 updates the content path in the file, so that the information pertaining to the object indicates the location of the modified object. According to an exemplary embodiment, updating module 206 can contain a publishing module. The publishing module publishes the content path in the file. In the above-mentioned example file, described in conjunction with FIG. 2, the ’web server/objects/static. jpg’ can be considered as the content path, which indicates the location of the modified object.

In an alternate embodiment, the publishing module can publish a URL path, which indicates the location of the file. Web cache 106 can access the file by using the published URL path. In an exemplary embodiment, web cache 106 sends a request for the objects on web server 104. While sending a response to web cache 106, web server 104 includes the URL path of the file in the response header. An example of the response header is elaborated on as follows:
HTTP/1.0 200 OK
Content-Type: text/html
Content -Length: 2366
Date: Thursday, 19 May 2005, 10:21:23 GMT
X-Updated File-Log: /pub/.active_cache_log.clog
   In this case, web cache 106 can make a request for the file at the location specified by the URL path provided in the response header. In the example of the response header, mentioned above, web cache 106 can access the file ‘.active_cache_log.clog’ at the URL path ‘/pub/.active_cache_log.clog’. In an alternate embodiment, the publishing module publishes a URL, which provides the location at which the file can be accessed. An example of the URL is http://www.cisco.com/.active_cache_log.clog. In this case, web cache 106 can access the file by using the published URL. In another embodiment, the convention of naming the URL can be standardized. The standardized URL can be accessed by web cache 106, by using a standard hyper text transfer protocol (HTTP). In various embodiments, web cache 106 accesses the file on web server 104 through communicating module 202.

Further, communication module 202 provides the method by which communication of information can take place between web server 104 and web cache 106. The method by which the communication takes place has been described in conjunction with FIG. 2. In an embodiment of the invention, communication module 202 communicates only the modified objects of the file to web cache 106. In an embodiment of the invention, web cache 106 can communicate its current version of the file to web server 104. For example, web cache 106 can send a HTTP request that includes the current version of the file in the request header of the HTTP request. If the current version of the file is of a lower version than the version of the file on web server 104, it indicates that the objects on web server 104 have been modified. Thereafter, web server 104 can send only the modified objects to web cache 106. According to various embodiments of the invention, web server 104 sends a list of objects that are indicated in the file but are not indicated in the current version of the file. In an embodiment, communication module 202 can be present in network 108 as a part of web server 104. In another embodiment, communication module 202 can be a part of web cache 106. In yet another embodiment, communication module 202 can be independent of web server 104 and the web cache 106.

Web cache 106 uses the file to update the cached objects. Further, web cache 106 includes a validating module 208, which validates the cached objects in web cache 106 on the basis of the information in the file at web server 104. Validation of the cached objects involves updating them. In one embodiment, validating module 208 comprises a comparing module, which compares the information pertaining to the objects indicated in the file with the cached objects in web cache 106. The comparing module determines which cached objects need validation. In one embodiment, the comparing module compares the time stamp corresponding to an object in the file with the time stamp corresponding to the copy of the same object in the cache. If the two time stamps are different, the comparing module indicates that they require validation. In this manner, the comparing module can also determine the list of the cached objects that require validation. In one embodiment, web cache 106 receives only a list of objects that have been modified on web server 104. In this case, web cache 106 validates only the cached objects indicated in the received list of objects.

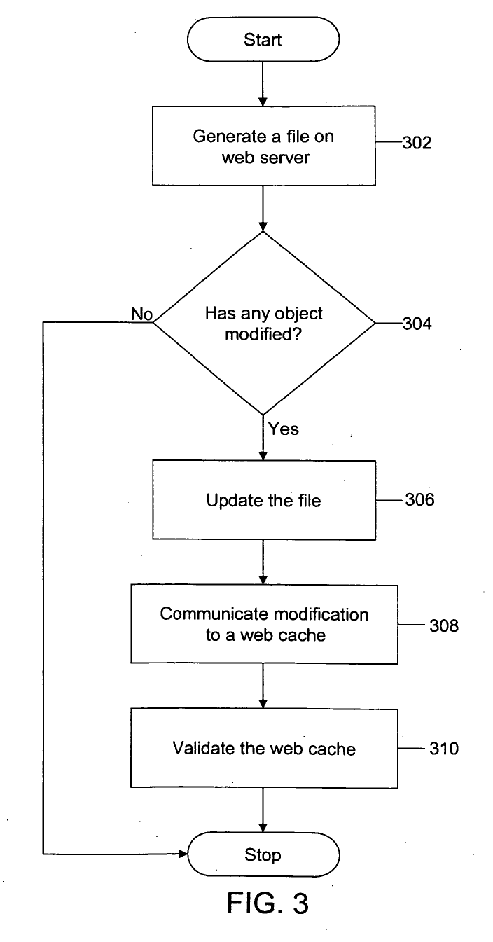

FIG. 3 is a flowchart depicting the requisite steps for communicating validation information, in accordance with an exemplary embodiment of the present invention. At step 302, the file containing the information related to the objects being served by web server 104 is generated. Details pertaining to the file being generated have already been described earlier in conjunction with FIG. 2. At step 304, it is checked whether at least one object in the file has been modified. If even one object served by web server 104 has been modified, then the system proceeds to step 306. According to an exemplary embodiment, an administrator of the computing device of web server 104 generates the file each time an object is modified. In another embodiment, generating module 202 generates the file each time the object on web server 104 is modified. At step 306, web server 104 updates the information pertaining to the objects in the file. According to the various embodiments of the invention, the file is updated by updating module 206.

In another embodiment, the publishing module publishes the content path of the object, which indicates the location at which the object is modified. At step 308, the information relating to the modified objects in the file is communicated to web cache 106. Various embodiments, for communicating the information to the web cache, have been described earlier in conjunction with FIG. 2. At step 310, web cache 106 validates its cached objects on the basis of the file. In an embodiment, the comparing module compares the time stamp corresponding to an object in the file with the time stamp of the cached object. On the basis of this comparison, the system, according to the various embodiments of the invention, determines whether the object requires validation. In this manner, the system can also determine the list of cached objects that require validation. Once the objects requiring validation are identified, validating module 206 validates them. In one embodiment, validating module 206 validates the cached objects requiring validation by replacing them with the corresponding copy of the modified objects on web server 104.

In an alternate embodiment, web cache 106 can cache a copy of the file on web server 104. In this case, web cache 106 can validate the cached file by the process mentioned above. According to an exemplary embodiment, the validation takes place periodically. According to another exemplary embodiment, web cache 106 validates the cached file when the objects in the file at web server 104 are modified.

Embodiments of the present invention provide a server-driven approach to ensure cache coherency. The embodiments of the invention propose mechanisms that optimize the process of proactive validation by proposing extensions to the web server and the web cache. In addition, the embodiments of the invention enable the web cache to proactively determine the list of objects that need to be validated, thereby avoiding the expense of explicitly validating each object in separate transactions. Further, an embodiment of the invention can create the file in an XML format, which facilitates easy deletion of and addition to the contents of the file. In another embodiment, the method of the invention eliminates the need to communicate the file, as a whole, to the web cache. This is enabled by the ability of the various embodiments of the invention to communicate information pertaining only to the modified objects to the web cache. This also reduces bandwidth requirements for communication of validation information to the web cache.

Although the invention has been discussed with respect to the specific embodiments thereof, these embodiments are merely illustrative, and not restrictive, of the invention.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process. The routines can operate in network environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nano engineered systems, components and mechanisms may be used. In general, the functions of the present invention can be achieved by any means as is known in the art. Distributed or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for communicating validation information from a web server to validate a web cache, the method comprising
generating a file on the web server, the file containing information relating to at least one object being served by the web server;
updating the contents of the file, the updating including modifying the information relating to the at least one object;
communicating the modifications in the updated file to the web cache; and
validating the contents of the web cache on the basis of the updated file.

2. The method of claim 1, wherein the generating the file comprises generating the file periodically.

3. The method of claim 1, wherein the generating the file comprises generating the file when the at least one object being served by the web server modifies.

4. The method of claim 1, wherein the updated file contains a timestamp, the timestamp indicating the time at which the at least one object is modified.

5. The method of claim 1, wherein the updated file contains a content path, the content path indicating the location at which the at least one object is modified.

6. The method of claim 1, wherein the communicating the modification comprises
receiving a request for access to the at least one object, the request being received by the web server; and
responding to the request, the response indicating the location of the updated file.

7. The method of claim 1, wherein the communicating the modifications comprises
publishing a URL, the URL indicating the location of the updated file; and
providing access to the published URL, to the web cache.

8. The method of claim 1, wherein the communicating the modifications further comprises
saving a copy of the updated file on the web cache; and
updating the saved copy of the updated file on the web cache.

9. The method of claim 8, wherein the updating is done periodically.

10. The method of claim 8, wherein the updating is done when the at least one object in the updated file modifies.

11. The method of claim 1, wherein the validating the contents comprises
comparing the information relating to the at least one object in the updated file with the information related to the object on the web cache; and
updating the object on the web cache if the information relating to the at least one object in the updated file indicates that the at least one object has modified.

12. The method of claim 11, wherein the updating the object in the web cache comprises replacing the object on the web cache with a copy of the at least one object on the web server.

13. A system for communicating validation information, the system comprising
means for generating a file in a web server, the file containing information relating to at least one object being served by the web server;
means for updating the contents of the file, the updating including modifying the information relating to the at least one object;
means for communicating the modifications in the updated file to a web cache; and
means for validating the contents of the web cache on the basis of the updated file.

14. A system for communicating validation information, the system comprising
a web server, the web server comprising
a generating module for generating a file in a web server, the file containing information relating to at least one object being served by the web server; and
an updating module for updating the contents of the file, the updating including modifying the information relating to the at least one object;
a web cache, the web cache comprising
a validating module for validating the contents of the web cache on the basis of the updated file; and
a communicating module for communicating the modifications in the updated file to the web cache.

15. The system of claim 14, wherein the updating module comprises a publishing module, the publishing module publishes a content path in the file, the content path indicating the location at which the at least one object is modified.

16. The system of claim 15, wherein the publishing module further comprises publishing a URL, the URL indicates the location of the updated file.

17. The system of claim 14, wherein the validating module comprises a comparing module, the comparing module compares the information relating to the at least one object in the updated file with the information related to the object in the web cache.

18. An apparatus for communicating validation information from a web server to validate a web cache, the apparatus comprising
a processing system including a processor coupled to a display and user input device;
a machine-readable medium including instructions executable by the processor comprising
one or more instructions for generating a file in the web server, the file containing information relating to at least one object being served by the web server;
one or more instructions for updating the contents of the file, the updating including modifying the information relating to the at least one object;
one or more instructions for communicating the modifications in the updated file to the web cache; and
one or more instructions for validating the contents of the web cache on the basis of the updated file.

19. A machine-readable medium including instructions for communicating validation information from a web server to validate a web cache, the medium comprising
one or more instructions for generating a file in the web server, the file containing information relating to at least one object being served by the web server;
one or more instructions for updating the contents of the file, the updating including modifying the information relating to the at least one object;
one or more instructions for communicating the modifications in the updated file to the web cache; and
one or more instructions for validating the contents of the web cache on the basis of the updated file.
